(19) United States
(12) Patent Application Publication
(10) Pub. No.: US 2025/0191856 A1
(43) Pub. Date: Jun. 12, 2025

(54) MULTI-FUNCTIONAL SWITCH DEVICE

(71) Applicants: HYUNDAI MOTOR COMPANY, Seoul (KR); KIA CORPORATION, Seoul (KR); ALPS ELECTRIC KOREA CO.,LTD., Gwangju (KR)

(72) Inventors: Sang Hoon Shin, Hwaseong-si (KR); Si Hyeong Yang, Gwangju (KR)

(73) Assignees: HYUNDAI MOTOR COMPANY, Seoul (KR); KIA CORPORATION, Seoul (KR); ALPS ELECTRIC KOREA CO.,LTD., Gwangju (KR)

(21) Appl. No.: 18/946,562

(22) Filed: Nov. 13, 2024

(30) Foreign Application Priority Data
Dec. 6, 2023 (KR) 10-2023-0175834

(51) Int. Cl. H01H 9/02; H02B 1/48

(52) U.S. Cl. CPC H01H 9/0271; H02B 1/48; H01H 2223/026

(57) ABSTRACT

A multi-functional switch device includes: an integral panel in which four button parts are formed on the upper surface thereof, and a hook hanger including a hook hole formed at and protruding from the bottom of each button part; and a case including a stopper disposed at an upper portion of the case, and a hook protruding upward at a position corresponding to each hook hanger, the case connected to the panel. The stopper is arranged so that each button part is operated in a seesaw manner. Each hook and the hook hole are coupled to form a set gap, so that when one button part is pushed, a stroke of the corresponding button part is possible and operation of the other button parts is restricted.

### CROSS-REFERENCE TO RELATED APPLICATION

This application claims priority to and the benefit of Korean Patent Application No. 10-2023-0175834 filed in the Korean Intellectual Property Office on Dec. 6, 2023, the entire contents of which are incorporated herein by reference.

### BACKGROUND

### (a) Technical Field

The present disclosure relates to a multi-functional switch device.

Particularly, the present disclosure relates to a multi-functional switch device which has an attractive appearance without a relatively large increase in cost.

### (b) Description of the Related Art

Typically, vehicles include various switches to execute various functions for controlling or actuating (e.g., turning on, turning off, changing one or more settings or a mode of operation of) devices such as doors, air conditioning, AVN (Audio Video Navigation), advanced driver assistance functions, autonomous driving functions, smart cars, and seat adjustment.

With the recent advancement of vehicle technology, devices that were previously operated mechanically are now being driven by electrical methods, and advanced functions are being added. However, there is a limit to the number of switches that may be added, so the trend is to integrate them into multi-function switches or increase the number of software switches that utilize displays.

For example, in recent electric vehicles (EVs), various function-specific menus are increasingly being integrated into the display. However, methods of executing functions using a display has the drawbacks of being unintuitive and having complicated menu execution.

In addition, the shape and structure of a switch disposed in the vehicle has value as an interior design element, and research and development are continuously being conducted on switches that allow the driver to easily execute various functions.

General mechanical switch devices can be relatively inexpensive, but there is a limit to the number of switches that may be added or included, and the degree of design freedom is relatively low.

The information contained in this background section has been prepared to enhance understanding of the background of the disclosure and may include matters that are not prior art already known to those of ordinary skill in the art.

### SUMMARY

The present disclosure provides a multi-functional switch device having an attractive appearance without increasing relative cost thereof.

A multi-functional switch device according to an embodiment may include: an integral panel in which four button parts are formed on the upper surface thereof, and a hook hanger including a hook hole formed at and protruding from the bottom of each button part; and a case including a stopper disposed at an upper portion of the case, and a hook protruding upward at a position corresponding to each hook hanger, the case connected to the panel. The stopper may be arranged so that each button part is operated in a seesaw manner. Each hook and the hook hole may be coupled to form a set gap, so that when one button part is pushed, a stroke of the corresponding button part is possible and operation of the other button parts is restricted.

The panel may include a plurality of bracket grooves formed on a lower surface of the panel so as to be seated on top of a stopper disposed in the case.

The panel may further include a button part protrusion formed on the lower surface of the panel to partition each button part.

the button part protrusion may be formed with a concave surface at one end to allow the button part protrusion to rotate while being seated on a cylindrical exterior circumference of the stopper.

The stopper may be installed in a non-operating region corresponding to the boundary between the button parts.

The hook hole may be formed with a predetermined gap on an upper side of the hook while the hook hole is in an engaged state in which its lower part is in contact with the hook.

The multi-functional switch device according to an embodiment may further include an upper cover which is connected to an upper part of the case and a button hole into which the panel is mounted.

The multi-functional switch device according to an embodiment may further include a connection protrusion formed in one of the upper cover and the case, and a connection hole formed in an other of the upper cover and the case and engaged with the connection protrusion.

The multi-functional switch device according to an embodiment may further include a guide groove formed in one of the upper cover and the case, and a guide protrusion formed on an other of the upper cover and the other of the case and inserted into the guide groove.

An opening may be formed in the panel, and the multi-functional switch device according to an embodiment may further include at least one of a return switch, a roller switch, or a knob switch disposed at the upper part of the case and exposed to an outside through the opening.

The panel may further include an input rod protruding from the bottom of each button part configured to operate a tact switch when the button part is operated.

In the case, a switch hole may be formed in which an actuator that operates the tact switch by the stroke movement of the input rod is inserted at a position corresponding to each input rod.

The multi-functional switch device according to an embodiment may further include a lower cover which is connected with the case and on which the tact switches, a PCB (Printed Circuit Board) mounting the tact switch, and the actuator are installed thereto. The tact switches may be installed at the bottom of each actuator and are configured to generate an operational signal according to the stroke operation.

The multi-functional switch device according to an embodiment may further include a protective cover mounted on the lower cover to protect circuit components mounted on the PCB.

A multi-functional switch device according to an embodiment may include: an integral panel in which a first button part and a second button part are formed on opposite sides of the upper surface, and a hook hanger including a hook hole formed on and protruding from the lower part of each of the first button part and the second button part, and a case including a stopper disposed at a boundary position of the first button part and the second button part, and a hook protruding upward at a position corresponding to each hook hanger, the case connected to the panel. The stopper may be arranged so that each button part is operated in a seesaw manner. Each hook and the hook hole may be coupled to form a set gap, so that when one button part is pushed, the stroke of the corresponding button part is possible and the operation of the other button parts is restricted.

The multi-functional switch device according to an embodiment may suppress error occurrence while maintaining the merit and benefits of an integrated and seamless appearance design.

The multi-functional switch device according to an embodiment may reduce manufacturing cost and be easily assembled.

The multi-functional switch device according to an embodiment can improve the quality of user operation by minimizing stroke operation when operating a button through an integrated operation structure and applying a structure that limits the rise of the other button region with respect to the pushed button region.

The multi-functional switch device according to an embodiment can prevent switch mis-operation and malfunction by applying the stopper to the boundary of a button region to prevent the button from operating even if a user presses a non-operating region.

In addition, any effects that can be obtained or expected due to an embodiment are directly or implicitly disclosed in the detailed description of an embodiment. That is, various effects predicted according to an embodiment are disclosed in the detailed description that follows.

### BRIEF DESCRIPTION OF THE DRAWINGS

Since these drawings are merely for reference in explaining embodiments of the present disclosure, the technical idea of the present disclosure should not be construed as being limited to the accompanying drawings.

FIG. 1 is a top plan view showing a multi-functional switch device according to an embodiment.

FIG. 2 is a partial top plan view of the multi-functional switch device according to an embodiment.

FIG. 3A is a top plan view showing an assembled structure of a panel and a case of the multi-functional switch device according to an embodiment.

FIG. 3B is a cross-sectional view showing button operations of the multi-functional switch device according to an embodiment.

FIG. 4 is a drawing showing a lower assembly structure of the panel according to an embodiment.

FIG. 5 is a drawing showing an upper assembly structure of the case according to an embodiment.

FIG. 6 shows an exploded perspective view of the multi-functional switch device according to an embodiment.

FIG. 7A illustrates a multi-functional switch device according to another embodiment of the present disclosure.

FIG. 7B illustrates operations of the multi-functional switch device according to the embodiment of FIG. 7A of the present disclosure.

FIG. 8A-FIG. 8C illustrate a multi-functional switch device according to yet another embodiment of the present disclosure.

FIG. 8D illustrates operations of the multi-functional switch device according to the embodiment of FIGS. 8A-8C of the present disclosure.

FIG. 9 is a drawing showing a typical hybrid touch type switch device.

FIG. 10A and FIG. 10B are cross-sectional views showing operations of a typical hybrid touch-type switch device.

FIG. 11A and FIG. 11B are cross-sectional views showing operations of a typical hybrid touch-type switch device and a typical mechanical switch device.

The drawings referenced above are not necessarily drawn to scale, but should be understood as presenting a somewhat simplified representation of various features illustrating the basic principles of the present disclosure.

The specific design features of embodiments of the present disclosure, including, for example, specific dimensions, orientations, locations, and shapes, will be determined in part by the particular intended application and use environment.

### DETAILED DESCRIPTION

Hereinafter, with reference to the attached drawings, embodiments of the present disclosure are described in detail so that those of ordinary skill in the art can easily implement the present disclosure. As those having ordinary skill in the art should realize, the described embodiments may be modified in various different ways, all without departing from the spirit or scope of the inventive concept described herein.

The terminology used herein is for the purpose of describing specific embodiments of the disclosure only and is not intended to limit the disclosure.

As used herein, singular forms are intended to also include plural forms, unless the context clearly indicates otherwise.

As used herein, the terms ‘comprise’ and/or ‘comprising’ indicate the presence of specified features, integers, steps, operations, elements and/or components, but may also include one or more other features, integers or steps. It should also be understood that the terms ‘comprise’ and/or ‘comprising’ do not exclude the presence or addition of elements, operations, components, and/or groups thereof.

As used herein, the term ‘and/or’ includes any one or all combinations of one or more items listed in association.

Throughout the specification, the terms first, second, A, B, (a), (b), etc. may be used to describe various components, but the components should not be limited by the terms.

These terms are only intended to distinguish one component from another and do not limit the nature, order, or sequence of the component.

Throughout the specification, whenever a component is referred to as being ‘connected’ or ‘coupled’ to another component, it should be understood that it may be directly connected or coupled to that other component, but there may also be other components in between.

On the other hand, when it is said that a component is ‘directly connected’ or ‘directly coupled’ to another component, it should be understood that there are no other components in between.

Throughout the specification, the terminology used is for the purpose of describing particular embodiments only and is not intended to limit the present disclosure. When a component, device, element, or the like of the present disclosure is described as having a purpose or performing an operation, function, or the like, the component, device, or element should be considered herein as being “configured to” meet that purpose or perform that operation or function.

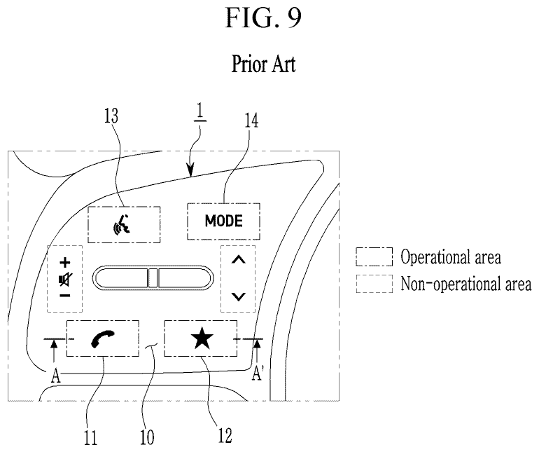

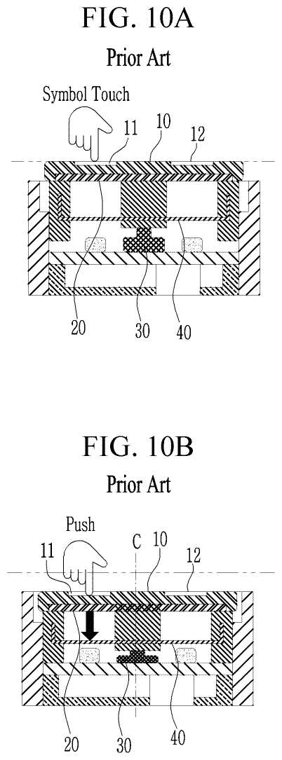

FIG. 9 is a drawing showing a typical hybrid touch type switch device. FIGS. 10A and 10B are cross-sectional views showing the operation of a typical hybrid touch type switch device.

Referring to FIGS. 9-10B, a typical hybrid touch type switch device 1 includes a plurality of function buttons 11 and 12 within the same panel 10 to achieve an integrated and seamless appearance.

The switch device 1 operates in such a way that when a user who has specified a button position through a touch sensor 20 applied to the panel 10 performs a touch and/or push operation on the panel 10, the contact point ON of the specified touch sensor 20 and tact switch 30 is detected, thereby determining the button function. A stabilizer 40 is applied so that the user can push without tilting even when pressing any part (ex: 11) other than the central portion C of the panel 10.

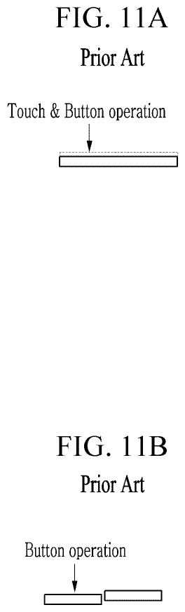

FIG. 11A and FIG. 11B are cross-sectional views showing the operation of a typical hybrid touch-type switch device and a typical mechanical switch device.

In the case of the hybrid touch type switch device, the entire panel moves downward when the user touches or operates the button. In the case of the mechanical individual button method, only the corresponding button of the switch device moves down when the user operates the button.

The general hybrid touch method switch device 1 uses the hybrid touch method to implement a unified and seamless appearance and design, but has the drawback of increased cost and lower operation quality compared to mechanical buttons. In addition, there is a problem that causes customer dissatisfaction as touch failure may occur due to restrictions on the region where the touch sensor is attached according to the panel shape or touch malfunction may occur depending on the touch recognition occupancy rate.

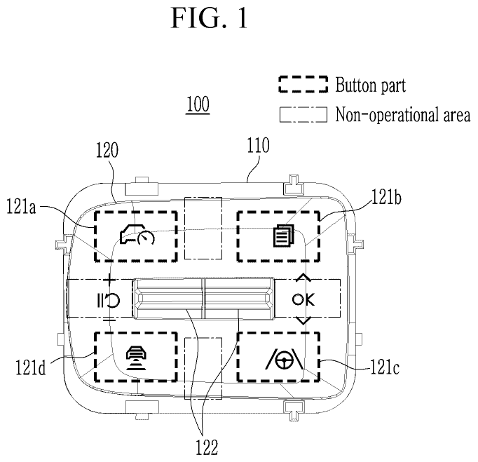

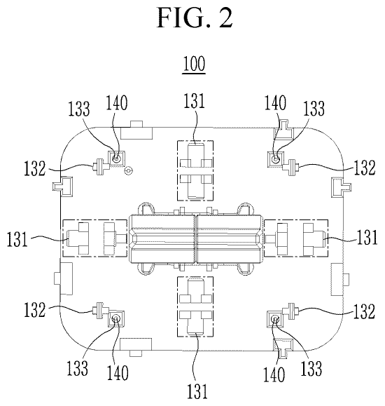

FIG. 1 is a top plan view showing a multi-functional switch device according to an embodiment of the present disclosure. FIG. 2 is a partial top plan view of the multi-functional switch device according to an embodiment of the present disclosure.

Referring to FIGS. 1 and 2, a multi-functional switch device 100 according to an embodiment may implement a seamless appearance and design identical to a hybrid touch-type switch device. Additionally, when a user operates a button, only the corresponding button may move downward, identical to the mechanical individual button type.

The multi-functional switch device 100 may minimize the seesaw or stroke operation when operating a button using the integrated operation structure. By applying a structure that limits the rise of the other button region with respect to the pushed button region, the multi-function switch device may provide the same operating experience as the mechanical individual button method.

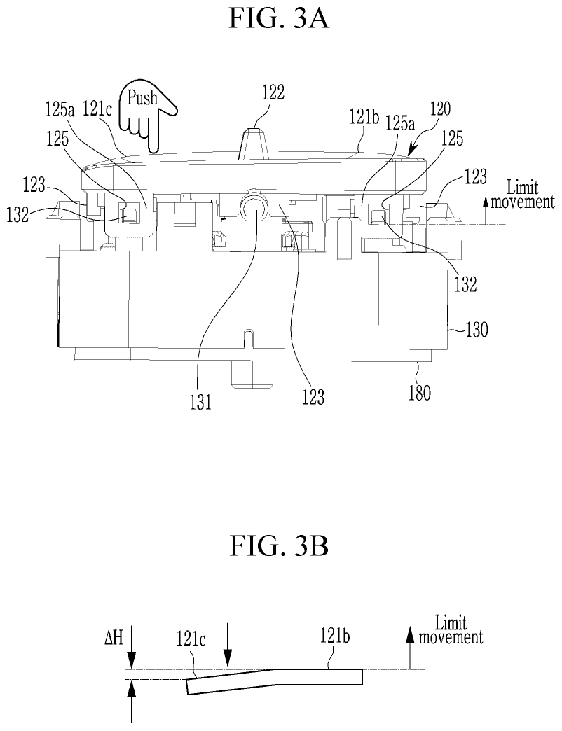

FIG. 3A is a top plan view showing an assembled structure of a panel and a case of the multi-functional switch device according to an embodiment of the present disclosure. FIG. 3B is a cross-sectional view showing button operations of the multi-functional switch device according to an embodiment of the present disclosure.

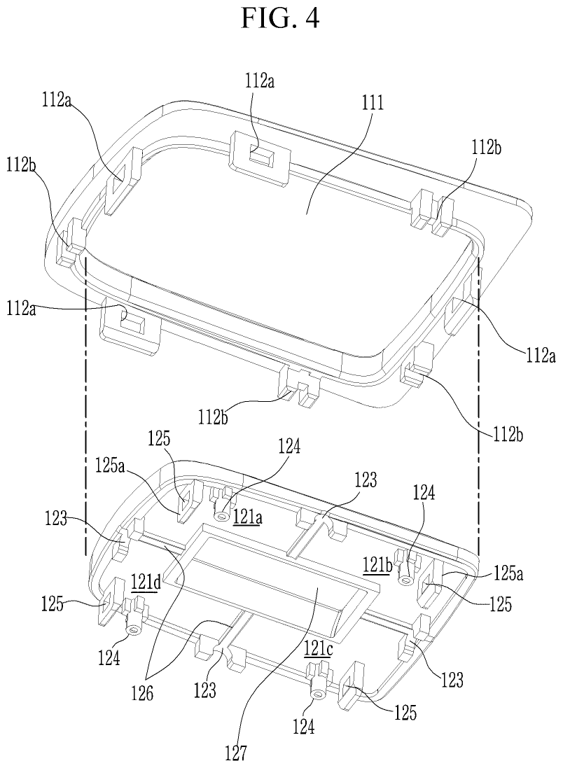

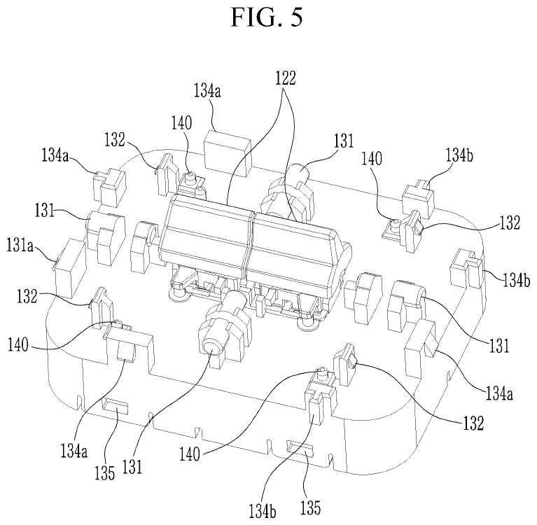

FIG. 4 is a drawing showing a lower assembly structure of the panel according to an embodiment. FIG. 5 is a drawing showing an upper assembly structure of the case according to an embodiment.

Referring to FIGS. 1-5, the multi-functional switch device 100 according to an embodiment includes an integral panel 120 having a button part 121 (e.g., 121a, 121b, 121c, 121d) formed thereon, and a case 130 having a stopper 131 disposed on an upper portion thereof, which is joined or coupled to a lower portion of the panel 120. For example, the stopper 131 may be disposed on an upper surface of the case 130.

The button part 121 is depicted as having four buttons 121a, 121b, 121c, and 121d formed in a diagonal direction on the upper surface of the panel 120, but is not limited thereto. In some examples, as shown in FIGS. 1 and 4, each of the buttons 121a, 121b, 121c, and 121d may be disposed in respective corner of the panel 120.

That is, the button part 121 may include various numbers of buttons and arrangements depending on the number of required functions.

A hook hanger 125a having a hook hole 125 may be formed at and protrude from the bottom of each of button parts 121a, 121 b, 121c, and 121d.

In the case 130, a hook 132 protrudes upward at a position corresponding to each hook hanger 125a.

The panel 120 is connected with the case 130 and the respective button parts 121a, 121b, 121c, and 121d can be operated in a seesaw manner by the stopper 131. For example, the panel 120 may be supported by one or more stoppers 131 disposed between the button parts 121a, 121b, 121c, and 121d of the panel 120.

Accordingly, when one of the button parts 121a, 121b, 121c, or 121d is moved (e.g., pressed) downwards, the panel 120 may rotate or pivot about one or more stoppers 131 such that the button parts 121a, 121b, 121c, 121d adjacent to the button part 121a, 121b, 121c, 121d which has been moved downward move in an opposite (e.g., upward) direction.

Each of the hooks 132 and the hook hole 125 are connected so as to form a predetermined gap or clearance (e.g., between the case 130 and the panel 120).

Through this, when one of the button parts 121a, 121b, 121c, and 121d is operated, the stroke ° H of the corresponding button part 121a, 121b, 121c, and 121d is permitted and the operation of the other button parts 121a, 121b, 121c, and 121d is restricted (e.g., movement of the other button parts 121a, 121b, 121c, and 121d, for example, in a direction opposite of movement of the operated button part 121a, 121b, 121c, and 121d, may be restricted).

Hereinafter, throughout the specification, the panel 120 refers to the “button” of the integral operating structure.

Therefore, operation of the panel has the same meaning as operation of the button in which one button part or region is pushed by the user.

Hereinafter, the components described below are described with reference or respect to the vertical direction. The parts facing upward may be named or described as the upper part, upper portion, and upper surface, and the parts facing downward may be named or described as the lower part, lower portion, and lower surface.

However, the direction or orientation of the components and their respective parts is relative. The direction may vary depending on the positions and/or orientations between the components and their respective parts. Accordingly, the present disclosure is not limited to the above reference direction or orientation of the present disclosure. The direction or orientation of the components and their respective parts should not be construed as limited to the reference direction used herein to describe embodiments of the present disclosure.

For example, the multi-functional switch device 100 may be installed on a vehicle's steering wheel, center fascia, door, center console, ceiling, and the like, depending on the installation angle and direction. The direction or orientation of components and their respective parts may be determined, in part, on a component of the vehicle on which the multi-functional switch 100 is installed.

Therefore, this specification describes the direction between parts by reference to at least a drawing.

The panel 120 includes a plurality of bracket grooves 123 formed on its lower surface to be seated on top of a stopper 131 disposed in the case 130.

The panel 120 includes button part protrusions 126 formed on the lower surface to partition the respective button parts 121a, 121b, 121c, and 121d.

The stopper 131 may have a cylindrical exterior circumference, and the button part protrusion 126 may be rotatably mounted on the cylindrical exterior circumference of the stopper 131 so that one end thereof may be formed as a concave curved surface.

The stopper 131 may be arranged in a cross shape, and the button part protrusion 126 may be formed in a cross shape corresponding to the arrangement of the stopper 131.

The stopper 131 is installed in the non-operating region corresponding to the boundary between each of button parts 121a, 121b, 121c, and 121d.

Therefore, the stoppers 131 may prevent mis-operation by restricting the panel (button) 120 from operating even if the user presses the non-operation region.

As shown in FIG. 3, the hook hole 125 forms a certain or predetermined amount of gap (clearance) only toward the upper side of the hook 132 (e.g., between an upper side of the hook and a top or upper side of the hook hole 125) when its lower part is engaged with the hook 132.

Therefore, when the user operates the button, only one of the pushed button parts (e.g., 121c) of the panel 120 is lowered by the predetermined amount of gap (clearance) (e.g., ^{Δ}H).

In contrast, the button part (ex: 121b, 121a, 121d) of the panel 120 on the other side has a structure that cannot rise because it is restrained by the hook 132 that is caught in the hook hole 125.

Unlike the general seesaw method which has a physical action where one side is pressed down to raise the other side, the panel 120 of the embodiment restricts the physical action of the seesaw method through the coupled structure of the hook 132 and the hook hole 125.

The panel 120 is made of an elastic material such as a synthetic resin and can be lowered and restored after being pushed (e.g., depressed).

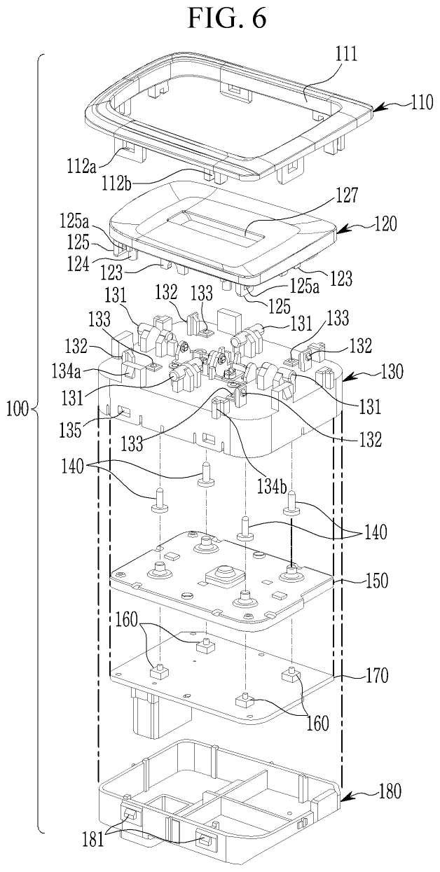

FIG. 6 shows an exploded perspective view of the multi-functional switch device according to an embodiment of the present disclosure.

Referring to FIGS. 1-6, the panel 120 is joined or coupled to the upper part of the case 130 through the upper cover 110 while being joined to the button hole 111 formed in the upper cover 110. For example, the panel 120 may be disposed above the case 130 when the panel 120 is coupled to the case 130.

A connection protrusion 134a is formed in one of the upper cover 110 and the case 130, and a connection hole 112a that is coupled with the connection protrusion 134a is formed in the other one of the upper cover 110 and the case 130.

The upper cover 110 and the case 130 can be firmly connected by the connection protrusion 134a and the connection hole 112a.

As shown in FIG. 6, the connection hole 112a is formed in the upper cover 110 and the connection protrusion 134a is formed in the case 130, however, the present disclosure is not limited to this configuration and the opposite configuration is also possible.

A guide groove 112b is formed in one of the upper cover 110 and the case 130, and a guide protrusion 134b inserted into the guide groove 112b is formed in the other of the upper cover 110 and the case 130.

When assembling the upper cover 110 and the case 130, the guide protrusion 134b is inserted into the guide groove 112b, so that the upper cover 110 and the case 130 may be easily assembled.

As shown in FIG. 6, the guide groove 112b is formed in the upper cover 110 and the guide protrusion 134b is formed in the case 130, however, the present disclosure is not limited to this configuration and the opposite configuration is also possible.

An opening 127 is formed in panel 120 so that a return switch 122 disposed at the top of case 130 may be exposed to the outside.

When a lever protruding outside of return switch 122 is operated, a switch signal is input, and if there is no operation, it can be returned to the original position.

The specific configuration and operation of this return switch 122 is well known to those having ordinary skill in the art, and thus a detailed description thereof has been omitted.

The panel further includes an input rod 124 protruding from the bottom of each button part 121a, 121 b, 121c, and 121d configured to operate a tact switch 160 when the button part 121a, 121b, 121c, and 121d is operated (e.g., pressed).

In the case 130, a switch hole 133 is formed corresponding to the input rod 124 of the panel 120, and an actuator 140 that operates the tact switch 160 with a stroke operation is inserted into the switch hole 133. A corresponding switch hole 133, input rod 124, actuator 140, and switch hole 133 may be provided for each of the button part 121a, 121b, 121c, and 121d.

The multi-functional switch device 100 according to an embodiment further includes a lower cover 180 coupled with the case 130 on which the tact switch 160 installed below each actuator 140 to generate an operation signal according to the stroke operation, a PCB (Printed Circuit Board) 170 on which the tact switches 160 are mounted, and the actuator 140 are installed.

The actuator 140 protrudes or extends in the length direction through the switch hole 133 formed in the case 130.

The PCB 170 mounts the tact switch 160, which is installed at the bottom of actuator 140. The tact switch 160 may be mounted to the PCS 170.

The PCB 170 may additionally mount another tact switch 160 corresponding to the return switch 122. Another or additional tact switch 160 may also be mounted to the PCB 170 for the return switch 122.

The tact switch 160 generates a corresponding operation signal (ON/OFF, etc.) according to the stroke operation of the actuator 140.

The multi-functional switch device 100 according to an embodiment further includes a protective cover 150 mounted on the lower cover 180 to protect the tact switch 160 and circuit components mounted on the PCB 170 from moisture or dust.

The protective cover 150 may be formed of, for example, rubber or silicone material.

The lower cover 180 is mechanically coupled with the case 130 to protect the actuator 140, the protective cover 150, the tact switch 160, and the PCB 170 installed inside.

The lower cover 180 and the case 130 are joined by connection protrusions 181 and case connection holes 135, which are installed in corresponding positions on each side, respectively.

The multi-functional switch device 100 may be applied to operate multi-function switches in various positions or locations, such as the steering wheel, center fascia, and console switch of a vehicle.

The multi-functional switch device 100 according to an embodiment provides a structure that enables the same switch operation or functionality as a mechanical individual button or method of operating a mechanical individual button while maintaining the merits or benefits of an integrated and seamless appearance design like a hybrid touch or method of operating a mechanical individual button, thereby reducing manufacturing costs and enabling simple assembly.

In addition, the user's operation quality can be improved by minimizing the seesaw or stroke operation when operating the button through the integrated operation structure and applying a structure that limits the rise of the other button region with respect to the pushed button region.

In addition, by applying the stopper to the border of the button region on both sides (non-operating region) formed on the integrated panel, the panel (button) is prevented from operating even if the user presses the non-operating region, thereby preventing switch mis-operation and malfunction.

Although the above has described an embodiment, the present disclosure is not limited to the above embodiment and various other changes are possible.

For example, in the above-described embodiment, four button parts 121a, 121b, 121c, and 121d are formed in a diagonal direction on the upper surface of the integral panel 120, and components of the case 130 corresponding to the four button parts are arranged.

However, embodiments of the present disclosure are not limited thereto, and embodiments of the present disclosure may provide multi-functional switch devices having various button structures.

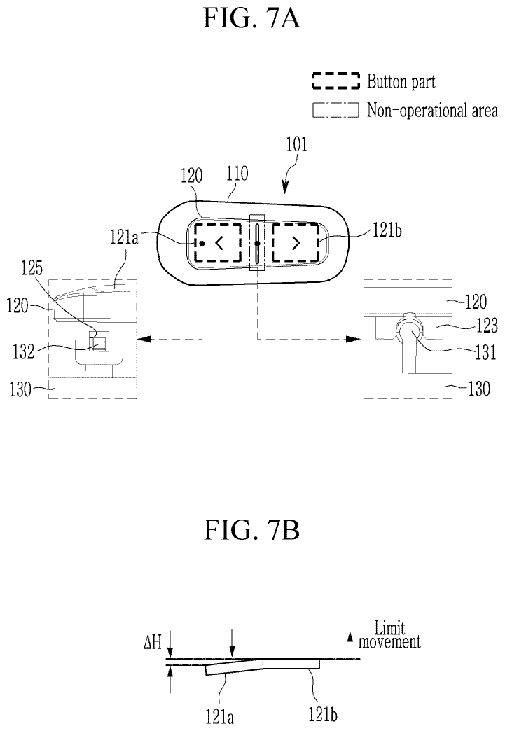

FIG. 7A illustrates a multi-functional switch device according to another embodiment of the present disclosure, and FIG. 7B illustrates operations of the multi-functional switch device according to the embodiment of FIG. 7A of the present disclosure.

In explaining the embodiment of FIG. 7A of the present disclosure, a duplicative description of portions of the multi-functional switch device 101 having the same configuration as the multi-functional switch device 100 according to the embodiment described above with respect to FIGS. 1-6 has been omitted and the other parts of the multi-functional switch device 101 are described below.

Referring to FIGS. 7A and 7B, a multi-functional switch device 101 according to another embodiment of the present disclosure includes an integral panel 120 having a first button part 121a and a second button part 121b formed on both (e.g., opposite) sides of an upper surface of the panel 120, and a case 130 joined to a lower portion of the panel 120.

A stopper 131 is disposed at the top of the case 130.

A hook hanger 125a having a hook hole 125 may be formed at and protrude from the lower portion of each of the first and second button parts 121a and 121b.

In the case 130, a hook 132 protrudes upwards at a position corresponding to each hook hanger 125a.

The panel 120 is coupled with the case 130 and the first and second button parts 121a, and 121b may be operated in a seesaw manner by the stopper 131.

Each of the hooks 132 and the hook hole 125 are joined so as to form a predetermined clearance.

For example, when the first button part 121a is operated (pushed), the stroke ^{Δ}H of the first button part 121a is permitted and the operation of the second button part 121b is restricted.

Any further explanation may refer to the above-mentioned embodiment, and repeated explanations are omitted.

According to the first modified embodiment of the present disclosure, the multi-functional switch device 101 is compactly configured so that it can be easily applied to various switch devices such as opening and closing a vehicle window or adjusting a seat.

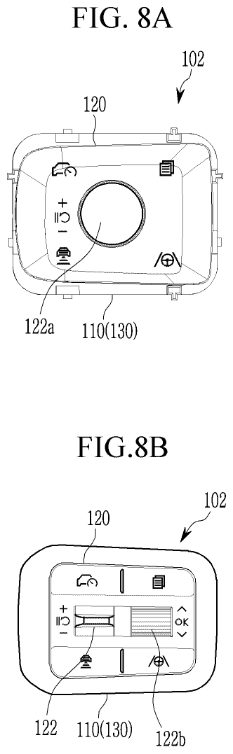

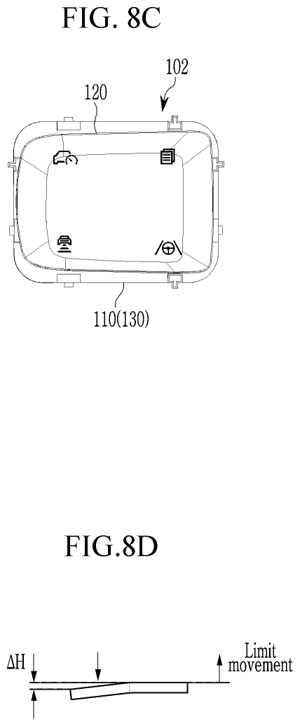

FIG. 8A-FIG. 8C illustrate a multi-functional switch device according to another embodiment of the present disclosure. FIG. 8D illustrates operation of the multi-functional switch device according to the embodiment of FIG. 8A-8C of the present disclosure.

In explaining the embodiment of FIG. 7A of the present disclosure, a duplicative description of portion of the multi-functional switch device 101 having the same configuration as the multi-functional switch device 100 according to the embodiment described above with respect to FIGS. 1-6 has been omitted and the other parts of the multifunctional switch device 101 described below.

Referring to FIGS. 8A-8D, a multi-functional switch device 102 according to an embodiment of the present disclosure may be configured with various heterogeneous switches, such as a combination of a knob-type switch 122a, a return switch 122, and a roller-type switch 122b, on the central portion of the panel 120.

Additionally, a separate switch may be omitted from the central portion of panel 120 and a 4-direction key type switch may be provided.

The panel 120 can be operated in a seesaw manner by the stopper 131 positioned between the button parts as described above.

The hook hole 125 installed on the lower surface of the button part engages the corresponding hook 132 with a (e.g., predetermined) clearance gap, thereby determining the stroke ^{Δ}H amount (e.g., height) when one button part is operated (pushed) while limiting the rise of the panel on the other side.

Any further explanation may refer to the above-mentioned embodiment, and repeated explanations are omitted.

According to the embodiment of FIGS. 8A-8C of the present disclosure, various heterogeneous switches such as a return switch 122, a knob-type switch 122a, and a roller-type switch 122b can be selectively applied or omitted as needed to the central portion of the multi-functional switch device 102, thereby securing flexibility in operation method and design.

While the present inventive concept has been described in connection with what is presently considered to be several practical embodiments, it should be understood that the present disclosure is not limited to the embodiments described herein. On the contrary, the present disclosure is intended to cover various modifications and equivalent arrangements included within the spirit and scope of the appended claims.

### DESCRIPTION OF SYMBOLS

100: multi-functional switch device
110: upper cover
111: button hole
112a: connection hole 112b: guide groove
120: panel
121 (121a, 121b, 121c, 121d): button part
122: return switch
123: bracket groove
124: input rod
125: hook hole 125a: hook hanger
126: button part protrusion
127: opening
130: case
131: stopper
132: hook
133: switch hole
134a: connection protrusion 134b: guide protrusion
135: case connection hole
140: actuator
150: protective cover
160: tact switch
170: printed circuit board (PCB)
180: lower cover
181: connection protrusion

What is claimed is:

1. A multi-functional switch device comprising:
an integral panel in which four button parts are formed on an upper surface thereof, and a hook hanger including a hook hole formed at and protruding from a bottom of each button part; and
a case including a stopper disposed at an upper portion of the case, and a hook protruding upward at a position corresponding to each hook hanger, the case connected to the panel,
wherein the stopper is arranged so that each button part is operated in a seesaw manner, and
each hook and the hook hole are coupled to form a set gap, so that when one button part is pushed, a stroke of the corresponding button part is possible and operation of the other button parts is restricted.

2. The multi-functional switch device of claim 1, wherein the panel comprises a plurality of bracket grooves formed on a lower surface of the panel so as to be seated on top of a stopper disposed in the case.

3. The multi-functional switch device of claim 2, wherein the panel further comprises a button part protrusion formed on the lower surface of the panel to partition each button part.

4. The multi-functional switch device of claim 3, wherein the button part protrusion is formed with a concave surface at one end to allow the button part protrusion to rotate while being seated on a cylindrical exterior circumference of the stopper.

5. The multi-functional switch device of claim 1, wherein the stopper is installed in a non-operating region corresponding to a boundary between the button parts.

6. The multi-functional switch device of claim 1, wherein the hook hole is formed with a predetermined gap on an upper side of the hook while the hook hole is in an engaged state in which a lower part of the hook hole is in contact with the hook.

7. The multi-functional switch device of claim 1, further comprising an upper cover which is connected to an upper part of the case and a button hole into which the panel is mounted.

8. The multi-functional switch device of claim 7, further comprising:
a connection protrusion formed in one of the upper cover and the case; and
a connection hole formed in an other of the upper cover and the case and engaged with the connection protrusion.

9. The multi-functional switch device of claim 7, further comprising:
a guide groove formed in one of the upper cover and the case; and
a guide protrusion formed on an other of the upper cover and the case and inserted into the guide groove.

10. The multi-functional switch device of claim 1, wherein an opening is formed in the panel, and
wherein the multi-functional switch device further comprises:
at least one of a return switch, a roller switch, or a knob switch disposed at an upper part of the case and exposed to an outside through the opening.

11. The multi-functional switch device of claim 1, wherein the panel further comprises an input rod protruding from the bottom of each button part configured to operate a tact switch when the button part is operated.

12. The multi-functional switch device of claim 11, wherein in the case, a switch hole is formed in which an actuator that operates the tact switch by a stroke movement of the input rod is inserted at a position corresponding to each input rod.

13. The multi-functional switch device of claim 12, further comprising a lower cover which is connected with the case and on which the tact switches, a PCB (Printed Circuit Board) mounting the tact switch, and the actuator are installed thereto,
wherein the tact switches are installed at the bottom of each actuator and are configured to generate an operational signal according to the stroke operation.

14. The multi-functional switch device of claim 13, further comprising a protective cover mounted on the lower cover to protect circuit components mounted on the PCB.

15. A multi-functional switch device comprising:
an integral panel in which a first button part and a second button part are formed on opposite sides of an upper surface, and a hook hanger including a hook hole formed on and protruding from a lower part of each of the first button part and the second button part; and
a case including a stopper disposed at a boundary position of the first button part and the second button part, and a hook protruding upward at a position corresponding to each hook hanger, the case connected to the panel, and
wherein the stopper is arranged so that each button part is operated in a seesaw manner, and
each hook and the hook hole are coupled to form a set gap, so that when one button part is pushed, a stroke of the corresponding button part is possible and operation of the other button parts is restricted.
